(19) United States
(12) Patent Application Publication
(10) Pub. No.: US 2026/0116769 A1
(43) Pub. Date: Apr. 30, 2026

(54) METHOD OF PRODUCING LITHIUM COMPOUNDS FROM LITHIUM-ION BATTERY WASTE

(71) Applicant: SEM Inc., Gyeonggi-do (KR)

(72) Inventors: Wook Jin CHUNG, Seoul (KR); Grace NISOLA, Gyeonggi-do (KR); John Edward SIO, Gyeonggi-do (KR); Sibag MARK, Gyeonggi-do (KR); Gebremedhn Tekeste GEBREMICHAEL, Gyeonggi-do (KR)

(21) Appl. No.: 19/364,082

(22) Filed: Oct. 21, 2025

(30) Foreign Application Priority Data
Oct. 30, 2024 (KR) 10-2024-0150877

(51) Int. Cl. C01D 15/02; C01D 15/08; C22B 26/12; H01M 10/54

(52) U.S. Cl. CPC C01D 15/02; C01D 15/08; H01M 10/54; C01P 2002/72; C01P 2006/40; C22B 26/12

(57) ABSTRACT

The present disclosure relates to a method of producing lithium compounds from lithium-ion battery waste, and products such as LiOH anhydride, LiOH hydrate or Li₂CO₃ may be obtained through, after separating black mass, performing alkali washing, thermal treatment, acid leaching and conversion thereon. The method reduces the amount of water used and increases a yield of the products through increasing thermal treatment and acid leaching efficiency, thereby providing an environment-friendly lithium-ion battery recycling method.

### CROSS-REFERENCE TO RELATED APPLICATIONS

This application claims priority to and the benefit of Korean Patent Application No. 10-2024-0150877, filed in the Korean Intellectual Property Office on Oct. 30, 2024, the entire contents of which are incorporated herein by reference.

### FIELD

The present disclosure relates to a method of producing lithium compounds from lithium-ion battery waste.

### BACKGROUND

With their high energy density, stability, and excellence in charge and discharge performance, lithium-ion batteries (LIB) are widely used from small devices such as mobile phones, computers and power tools to medium- to large-sized devices powered by electric motors such as electric vehicles including electric vehicles (EV), hybrid electric vehicles (HEV) and plug-in hybrid electric vehicles (PHEV); electric two-wheeled vehicles including electric bikes (E-bikes) and electric scooters (E-scooters); electric golf carts; and systems for power storage, and the demand is steadily increasing.

With the rising demand for LIBs, the need for various lithium precursor compounds such as LiOH (lithium hydroxide anhydride), LiOH·H₂O (lithium hydroxide monohydrate) and Li₂CO₃ (lithium carbonate) is also increasing. The existing lithium precursor compounds have been generally obtained from non-renewable resources such as salt lakes or spodumene, but they commonly have had problems of accompanying destruction of surrounding ecosystems, water waste, and environmental contamination such as soil contamination during the production process. Meanwhile, as the use of lithium-ion batteries increases, environment-friendly methods for battery disposal are being studied, and recently, more sustainable options using lithium-ion battery waste are receiving attention. Producing lithium compounds from lithium-ion battery waste may preserve the environment, prevent resource depletion, and lower reliance on non-renewable resources in countries that are not lithium producing countries, thereby promoting global resource distribution.

Black mass (BM) is a material derived during a recycling process of lithium-ion battery waste, and includes not only lithium, but also other rare metals such as nickel and cobalt. Black mass may be obtained by separating positive electrode and negative electrode active materials from other components of a lithium-ion battery such as a separator, a binder and an electrolyte through discharging, mechanical disassembly and crushing of the lithium-ion battery. The positive electrode and negative electrode active materials may still include a binder, and black mass may be obtained by removing the binder through thermal or chemical treatment. However, the obtaining process as above is incomplete, and the black mass may still include, as impurities, organic substances, graphite, aluminum, copper, iron and fluorine derived from a binder, an electrode plate or electrolyte, which remains as a challenge in preparing lithium compounds through black mass recycling.

### SUMMARY

The present disclosure relates to a method of producing lithium compounds using black mass separated from lithium-ion battery waste.

One embodiment of the present disclosure provides a method of producing lithium compounds from lithium-ion battery waste, the method comprising: separating black mass from lithium-ion battery waste; alkali washing the black mass; performing thermal treatment (heat treatment) on the alkali-washed black mass with a reductant; acid leaching the heat-treated black mass; and converting the acid leachate into lithium compounds.

The black mass may include LiₐMe_{b}O_{c} (Me is at least one selected from the group consisting of Ni, Co, Mn, Al, Cu, Fe, Mg, B, Ga, Zn, Ta and V, and a, b and c are each independently a real number of 0.01 or more), and impurities that do not include lithium.

The black mass may include particles having a particle diameter of 100 μm or less.

The alkali washing may be performed at a solid-liquid ratio of 250 g/L to 1000 g/L using a 1 M to 5 M NaOH or KOH solution.

The reductant may be at least one solid reductant selected from the group consisting of carbamide, ammonium carbonate, ammonium formate, ammonium oxalate and ammonium carbamate, at least one gas reductant selected from the group consisting of ammonia, hydrogen and carbon monoxide, or a combination thereof.

The thermal treatment may involve mixing the alkali-washed black mass and the solid reductant in a mass ratio of 1:0.1 to 1:2 and heat treating the mixture.

The thermal treatment may involve heating the mixture to 400° C. to 650° C. under an inert gas.

The acid leaching may involve adding an acid to the heat-treated black mass at a solid-liquid ratio of 40 g/L to 80 g/L to maintain a pH at 1 to 4.

The converting into lithium compounds may involve adding NaOH to the acid leachate to obtain LiOH or a hydrate thereof.

The converting into lithium compounds may involve adding Na₂CO₃ to the acid leachate to obtain Li₂CO₃.

The converting into lithium compounds may further include adding Ca(OH)₂ to the Li₂CO₃ to produce LiOH or a hydrate thereof.

The method of producing lithium compounds according to the present disclosure is capable of producing lithium compounds with high purity by selectively recovering lithium ions from black mass.

### BRIEF DESCRIPTION OF DRAWINGS

FIG. 1 is a schematic diagram illustrating a method of producing lithium compounds according to one embodiment of the present disclosure step by step.

FIG. 2A shows a TGA/DTG curve obtained by thermogravimetrically analyzing black mass obtained in one embodiment of the present disclosure, and FIG. 2B shows a graph identifying particle size distribution of the black mass measured in accordance with ASTM E11.

FIGS. 3A, 3B, 3C, and 3D are SEM images of black mass obtained in one embodiment of the present disclosure.

FIG. 4A indicates a graphite region in the SEM image of the black mass obtained in one embodiment of the present disclosure, and FIG. 4B shows images obtained by EDS analyzing and mapping the region by elements (O, F, P, S, C, Na, Al and Ni).

FIG. 5A indicates an NCM region (active material) in the SEM image of the black mass obtained in one embodiment of the present disclosure, and FIG. 5B shows images obtained by EDS analyzing and mapping the corresponding region by elements (O, Mn, Co, C, Ni, Na, Al and Cu).

FIGS. 6A, 6B, and 6C show XRD spectra of components included in the black mass obtained in one embodiment of the present disclosure.

FIG. 7 is a schematic diagram illustrating a method of producing lithium compounds according to one embodiment of the present disclosure step by step.

FIG. 8 is a schematic diagram illustrating a method of producing lithium compounds according to one embodiment of the present disclosure step by step.

FIG. 9 shows results of XPS analysis of the black mass before and after alkali washing, and after thermal treatment according to one embodiment of the present disclosure.

FIG. 10A shows XRD spectra before and after alkali washing according to one embodiment of the present disclosure, FIG. 10B shows XRD spectra between 2θ=18° to 25° of BM-3 heat treated after the alkali washing, FIG. 10C shows XRD spectra between 2θ=30° to 80° of BM-3 heat treated after the alkali washing, and FIG. 10D shows XRD spectra before and after leaching according to one embodiment of the present disclosure.

FIGS. 11A, 11B, 11C, and 11D are images showing changes in the black mass obtained during the process of producing lithium compounds according to one embodiment of the present disclosure when a magnet is touched thereto.

FIGS. 12A, 12B, 12C, and 12D are SEM images of black mass obtained during the process of producing lithium compounds according to one embodiment of the present disclosure.

FIGS. 13A, 13B, 13C, and 13D are SEM images of black mass obtained during the process of producing lithium compounds according to one embodiment of the present disclosure.

FIG. 14A shows total lithium leaching efficiency depending on whether alkali washing is performed or not, and FIG. 14B is a graph showing total lithium leaching efficiency for black mass heat treated while varying the ratio of a solid reductant used after alkali washing, and the use of a reducing gas.

FIGS. 15A, 15B, 15C, and 15D are graphs showing, during the process of producing lithium compounds according to one embodiment of the present disclosure, 15A lithium recovery efficiency depending on the ratio of a solid reductant, 15B lithium recovery efficiency depending on the ratio of a solid reductant during thermal treatment, 15C lithium recovery efficiency depending on the ratio of a solid reductant during leaching, and 15D total lithium recovery efficiency depending on the ratio of a solid reductant.

FIGS. 16A, 16B, and 16C are images of 16A LiOH obtained in Example 2, 16B Li₂CO₃ obtained in Example 3, and 16C LiOH obtained in Example 4.

FIGS. 17A and 17B show results of XRD analyses of a final product (product) obtained in one embodiment of the present disclosure and a commercially available product (comm).

### DETAILED DESCRIPTION

Hereinafter, each constitution of the present disclosure will be described in more detail so that those having common knowledge in the art may readily carry out the present disclosure, however, this is just one example, and the scope of a right of the present disclosure is not limited by the following.

The term “include (comprise)” used in the present specification is used to list materials, compositions, devices and methods useful for the present disclosure, and is not limited to the listed examples.

“About” and “substantially” used in the present specification are used to refer to, considering unique manufacturing and material tolerances, a range of the number or degree or as a meaning close thereto, and are used to prevent infringers from unfairly using the disclosure stating precise or absolute numbers provided to help understand the present disclosure.

A “lithium-ion battery” used in the present specification refers to a secondary battery, a super capacitor or the like in which lithium ions migrate from a negative electrode to a positive electrode during a discharge process.

A “lithium compound” used in the present specification is LiOH, LiOH·H₂O, Li₂CO₃ or a mixture thereof, and refers to a lithium precursor compound that may be used in the manufacture of a lithium-ion battery.

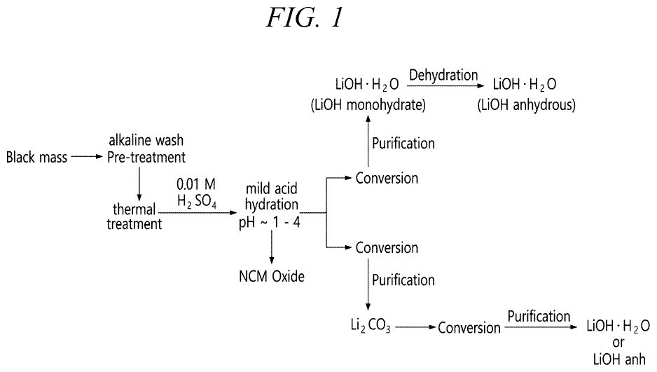

One embodiment of the present disclosure provides a method of producing lithium compounds from lithium-ion battery waste, the method including: separating black mass from lithium-ion battery waste; alkali washing the black mass; performing thermal treatment on the alkali-washed black mass with a reductant; acid leaching the heat-treated black mass; and converting the acid leachate into lithium compounds. FIG. 1 is a schematic diagram illustrating a method of producing lithium compounds according to this embodiment.

The separating of black mass from lithium-ion battery waste involves removing a case, a pouch, a separator, an electrolyte liquid, an electrode plate and an electrode binder among components of the lithium-ion battery waste, and obtaining an electrode active material. The separation may include a process of physically or chemically separating or removing any one of the components from other components, but is not limited thereto.

The black mass may include LiₐMe_{b}O_{c} (Me is at least one selected from the group consisting of Ni, Co, Mn, Al, Cu, Fe, Mg, B, Ga, Zn, Ta and V, and a, b and c are each independently a real number of 0.01 or more), and impurities that do not include lithium. The LiₐMe_{b}O_{c} refers to a lithium composite oxide derived from the electrode active material. The lithium composite oxide may be, for example, lithium nickel oxide such as chemical formula LiNi₁₋ₓMₓO₂ (herein, M is Co, Mn, Al, Cu, Fe, Mg, B, Ga, Zn or Ta, and x is from 0.01 to 0.3) or LiNiO₂; lithium cobalt oxide such as LiCoO₂; lithium manganese oxide such as chemical formula Li₁₊ₓMn₂₋ₓO₄ (herein, x is from 0 to 0.33), LiMnO₃, LiMn₂O₃, LiMn₂O₄, LiMnO₂ or Li₂Mn₃MO₈ (herein, M=Fe, Co, Ni, Cu or Zn); or lithium copper oxide such as Li₂CuO₂, but is not limited thereto.

The impurities that do not include lithium collectively refer to remaining organic substances, inorganic substances and organic-inorganic composites that may be included in lithium-ion battery waste other than the lithium composite oxide. The inorganic substance may include a metal element, a metal oxide, a metal hydroxide or a combination thereof. The black mass may include about 40% by weight to 75% by weight of impurities, however, the content of the impurities may vary depending on the black mass separation process.

The black mass may include particles having a particle diameter of 100 μm or less. Separating the black mass from lithium-ion battery waste may involve physically crushing the black mass of the lithium ion waste to have a particle diameter of 100 μm or less. The shape of the black mass may be a regular shape such as a sphere, an oval or a polygon, an amorphous shape or a combination thereof, however, the shape is not limited thereto, and any shape that forms a particle having a long side of 100 μm or less is sufficient. When the particle diameter of the black mass is more than 100 μm, it is difficult to secure lithium compound conversion efficiency according to the method of one embodiment of the present disclosure. Referring to FIG. 1, the black mass may be obtained in a black powder form.

The alkali washing of the black mass involves removing substances that may reduce efficiency of thermal treatment or acid leaching to be described later. The alkali washing involves washing the black mass with an alkali solution. The alkali washing may involve removing one or more including organic substances, and elements such as aluminum, copper, iron and fluorine included in the impurities described above as the material. The alkali washing may not elute lithium, cobalt, nickel, manganese, or composite oxides including one or more thereof. Preferably, the alkali washing may involve not dissolving and removing lithium, nickel, manganese and cobalt.

The alkali solution may be a NaOH or KOH solution. The alkali solution may effectively remove impurities such as hydrolysates of PVDF included in a lithium-ion battery, and fluorine derived from PVDF or LiPF₆ included in the electrolyte. For example, partially decomposed PVDF may be decomposed into water-soluble NaF and small organic substance fragments as hydroxide ions replace fluorine. For example, LiPF₆ may be decomposed into LiF, HF and POF₃, and POF₃ may be hydrolyzed into NaF and Na₃PO₄. It is not recommended to use a strong chelating solution such as ammonia water as the alkali solution since it may elute nickel, cobalt or manganese, and an acidic solution may cause unwanted metal loss.

The alkali washing may be performed using 1 M to 5 M of NaOH or KOH solution at a solid-liquid ratio of 250 g/L to 1000 g/L. Specifically, as the NaOH or KOH solution, those having a concentration of 1 M or more, 2 M or more, 3 M or more or 4 M or more, or 5 M or less, 4 M or less, 3 M or less or 2 M or less may be used. Preferably, the NaOH or KOH solution may have a concentration of 1 M or more and 4 M or less. Most preferably, the NaOH or KOH solution may have a concentration of 1 M or more and 2 M or less. Specifically, the solid-liquid ratio may be 250 g/L or more and 1000 g/L or less, 400 g/L or more and 850 g/L or less, or 550 g/L or more and 700 g/L or less. Preferably, the solid-liquid ratio may be 250 g/L or more and 600 g/L or less. Under the above-described concentration and solid-liquid ratio, efficiency of thermal treatment or acid leaching may be increased while minimizing dissolution or loss of lithium in the black mass to be produced into lithium compounds. The alkali washing may be performed at room temperature for 10 minutes to 2 hours with stirring at 100 rpm to 300 rpm.

The alkali washing of the black mass may further include washing the black mass with water for 10 minutes at a solid-liquid ratio of 500 g/L to 1000 g/L to remove residual fluorine impurities.

The alkali washing of the black mass may further include separating the alkali-washed black mass. The black mass may be separated through simple precipitation in order to remove the alkali solution. Alternatively, the alkali solution may be removed through drying. The drying may involve drying through natural drying, hot-air drying using an oven or low-temperature heating (for example, 36 hours at 85° C.), but is not limited thereto. The drying may increase efficiency of thermal treatment to be described later.

The thermal treatment of the alkali-washed black mass with a reductant involves heating a mixture of the black mass and the reductant for thermal reduction. The thermal reduction involves converting the lithium composite oxide (LiₐMe_{b}O_{c}) included in the black mass into a low-valent metal oxide or metal element. The low-valent metal oxide may refer to a metal oxide having a lower metal oxidation number compared to the lithium composite oxide, and the low-valent metal oxide may be additionally reduced to be converted into a metal element. For example, the thermal treatment may convert LiMeO₂ (Me is as described above) as the lithium composite oxide into Me₃O₄, MeO or zero-valent Me, and may produce Li₂CO₃ at the same time. The thermal treatment may involve placing a mixture of the black mass and the reductant in a furnace, and heating the mixture. The heat-treated black mass includes Li₂CO₃, and may further include the low-valent metal oxide, the metal element and at least some of the impurities.

The thermal treatment may be performed in the form of heating in a tube-type, roller-type or rotation-type furnace, however, the furnace type is not limited thereto. For example, the thermal treatment may be performed in a rotation-type furnace, and operating at 6 rpm to 12 rpm may minimize physical loss of the black mass while minimizing dust inflow.

The reductant may be a solid reductant (SR), a gas reductant or a combination thereof. Preferably, the reductant may be the solid reductant. Most preferably, the reductant may be a combination of the solid reductant and the gas reductant.

The solid reductant is capable of producing carbon while being heated together with the alkali-washed black mass. The solid reductant may be a compound capable of producing a reducing gas such as ammonia, hydrogen or carbon monoxide in a temperature range of 60° C. to 900° C. For example, the solid reductant may be at least one selected from the group consisting of carbamide, ammonium carbonate, ammonium formate, ammonium oxalate and ammonium carbamate. Preferably, the solid reductant may be carbamide.

The gas reductant may be used alone, but may also be used as an auxiliary reductant for the solid reductant. The gas reductant may increase efficiency of thermal reduction of the alkali-washed black mass. When the gas reductant is used alone, it needs to be used in an excessive amount compared to when used in combination with the solid reductant. When a combination of the solid reductant and the gas reductant is used, the gas reductant may not only increase the efficiency of thermal reduction, but also contribute to improving efficiency of acid leaching to be described later. The gas reductant may be at least one selected from the group consisting of ammonia, hydrogen and carbon monoxide.

The thermal treatment of the alkali-washed black mass together with a reductant may involve mixing the alkali-washed black mass and the solid reductant in a weight ratio of 1:0.1 to 1:2, and heat treating the mixture. Specifically, the weight ratio between the alkali-washed black mass and the solid reductant may be set within a range of 1:0.1 to 1:2. The solid reductant may efficiently heat treat the alkali-washed black mass in the above-described weight ratio. Preferably, the alkali-washed black mass and the solid reductant may have a weight ratio of 1:0.1 to 1:0.5. In a weight ratio of 1:0.5 or less, Mn included in the black mass is MnO, and nickel and cobalt may be reduced to zero-valent metals, minimizing co-leaching with lithium. The black mass may be heat treated in a range of more than 1:0.5 and 1:2 or less, however, the heat-treated black mass may agglomerate with each other or adhere to the wall of the furnace in which thermal treatment is performed, further requiring a device or process that physically mixes the mixture in the furnace.

The thermal treatment of the alkali-washed black mass with a reductant may involve heating these to 400° C. to 650° C. under an inert gas. The type of inert gas may be argon or nitrogen, but is not limited thereto. For example, the mixture of the alkali-washed black mass and the reductant is placed inside the furnace, the furnace is filled with argon or nitrogen gas, and then the mixture may be heated for 10 minutes to 4 hours at 400° C. to 650° C. at a heating rate of 10° C./minute to 50° C./minute. When the heat treatment temperature is lower than 400° C., it is difficult to sufficiently produce Li₂CO₃ through thermal reduction of the black mass, and when the heat treatment temperature is higher than 650° C., the mixture may react with refractories forming the furnace, may be corroded, may be melted before metal oxides in the impurities are reduced, or may undergo melt reduction, and as a result, the yield of target lithium compounds may be reduced. Preferably, the thermal treatment may involve heating for 30 minutes to 80 minutes at 500° C. to 550° C.

The acid leaching of the heat-treated black mass may be adding an acid to the heat-treated black mass to form Li₂SO₄ from the Li₂CO₃. The acid leaching involves releasing the carbonate component (CO₃²⁻) included in the heat-treated black mass as CO₂ gas, and obtaining lithium in the form of Li₂SO₄ having high solubility.

The acid leaching of the heat-treated black mass may involve adding an acid to the heat-treated black mass at a solid-liquid ratio of 40 g/L to 80 g/L to maintain the pH at 1 to 4. When the pH is maintained at 1 to 4 as a result of the acid leaching, the carbonate component included in the black mass may be released as CO₂ gas. The acid may be a slightly acidic H₂SO₄ solution having a pH of 1 to 3. Specifically, the solid-liquid ratio may be 40 g/L or more and 80 g/L or less, 45 g/L or more and 75 g/L or less, 50 g/L or more and 70 g/L or less, or 55 g/L or more and 65 g/L or less. Through maintaining the pH and the concentration under the above-described solid-liquid ratio, Li₂SO₄ having high solubility for water (255 g/kg H₂O) may remain in the solution. For example, the acid leaching may be performed by adding 0.01 M of H₂SO₄ to the heat-treated black mass at room temperature, and stirring the mixture for 10 minutes to 3 hours at 100 rpm to 400 rpm (refer to FIG. 1). Preferably, the slightly acidic H₂SO₄ solution may have a concentration of 0.01 M.

The acid leaching of the heat-treated black mass may further include solid-liquid separation of separating insoluble substances after adding the acid. By the acid leaching, a solution in which Li₂SO₄ is dissolved and insoluble substances in the solution may remain, and the insoluble substances may be removed through the solid-liquid separation. The insoluble substance may include metal oxides, metal elements, and at least some of the impurities. Referring to FIG. 1, the insoluble substance may include NCM oxide, and the NCM oxide may also be recycled in lithium secondary battery production. The solid-liquid separation may use membrane filtration, centrifugation, magnetic separation or a combination thereof, but is not limited thereto.

The acid leaching of the heat-treated black mass may be performed repeatedly. For example, an acid is added to the heat-treated first black mass, the pH is adjusted to 1 to 4, then heat-treated second black mass is further added to the solid-liquid separated solution, and an acid may be additionally added to adjust the pH to 1 to 4. The acid leaching, the solid-liquid separation, and the black mass addition may be repeatedly performed until the concentration of the Li₂SO₄ solution reaches a predetermined level. Such repeated performance reduces the amount of water used, and may reduce the amount of water required to evaporate during the process of obtaining lithium compounds to be described later. For example, the Li₂SO₄ solution may include lithium ions in an amount of 1600 mg/L to 2000 mg/L, or Li₂SO₄ in an amount of 3 g/L to 4 g/L.

Although not shown, the method of producing lithium compounds may further include water leaching the heat-treated black mass. Specifically, the water leaching may be performed prior to the acid leaching described above. Li₂CO₃ included in the heat-treated black mass may be recovered by being dissolved in water (solubility: 12.8 g/kg H₂O). The water leaching may be performed at a solid-liquid ratio of 10 g/L or more and 30 g/L or less. Performing the acid leaching following the water leaching may maximize the recovery rate of lithium included in the black mass, and may reduce the amount of water used compared to when using the water leaching only.

The converting of the acid leachate into lithium compounds involves converting Li₂SO₄ included in the Li₂SO₄ solution into LiOH, a hydrate thereof or Li₂CO₃ to obtain these. The converting into lithium compounds may further include purifying, crystallizing, recrystallizing, dehydrating or drying the produced LiOH, hydrate thereof or Li₂CO₃.

The converting of the acid leachate into lithium compounds may involve adding NaOH to the acid leachate to obtain LiOH or a hydrate thereof. The addition of NaOH uses a method of forming a Gluaber's salt. The acid leachate may be a Li₂SO₄ solution, and by adding NaOH, a solution of LiOH and Na₂SO₄ may be produced. The LiOH may be obtained in an anhydride or monohydrate form.

The converting of the acid leachate into lithium compounds may involve adding Na₂CO₃ to the acid leachate to obtain Li₂CO₃. The acid leachate may be a Li₂SO₄ solution, and by adding Na₂CO₃, a Li₂CO₃ dispersion may be produced. The converting of the acid leachate into lithium compounds may further include adding Ca(OH)₂ to the Li₂CO₃ to produce LiOH or a hydrate thereof. By adding Ca(OH)₂ to the Li₂CO₃, a form of sludge including CaCO₃ may be separated, and LiOH or a hydrate thereof may be obtained.

The method of producing lithium compounds may further include dehydrating the lithium compounds. The lithium compound may be a LiOH hydrate, which may be dried under vacuum to produce LiOH anhydride. For example, the LiOH hydrate may be dried under vacuum at 60° C. to 80° C. for 12 hours to 48 hours to produce LiOH anhydride.

The method of producing lithium compounds may achieve a total lithium recovery rate of 80% or more through performing alkali washing, thermal treatment and acid leaching on the black mass.

Hereinafter, the present disclosure will be described in more detail through specific examples and experimental examples. The following examples and experimental examples are for illustrative purposes only, and the present disclosure is not limited by the following examples and experimental examples.

### Example 1. Separation of Black Mass from Lithium-Ion Battery Waste

A case of a lithium-ion battery was disassembled to obtain an electrode assembly from an electrolyte liquid. The electrode assembly was disassembled to remove a separator, and surfaces of the recovered positive electrode and negative electrode were scraped to obtain an active material. The black mass used in the following experiments is referred to as ‘BM-3’ (content of lithium metal component: 3% by weight).

### Experimental Example 1. Identification of Black Mass (BM-3) Properties

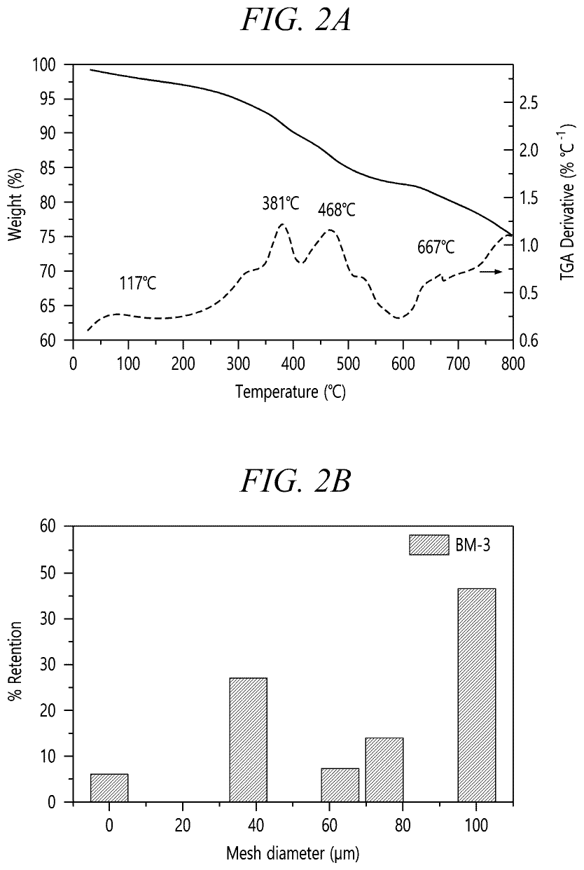

For the black mass obtained in Example 1, a thermogravimetric analysis (Mettler Toledo, TGA 2, measurement condition: 20° C. to 800° C., 20° C./minute under N₂) was performed under nitrogen gas, and the TGA/DTG curve is shown in FIG. 2A.

The dried black mass obtained in Example 1 was sieved using sieves of 100 μm, 75 μm, 63 μm and 38 μm in accordance with the method of ASTM E11 to identify the particle sizes, and the distribution is shown in FIG. 2B. Referring to FIG. 2B, the black mass was identified to have particle distribution of a particle diameter of 100 μm or less.

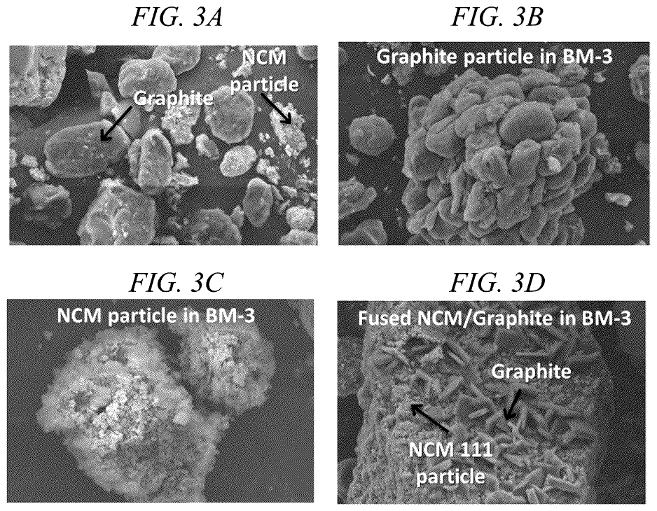

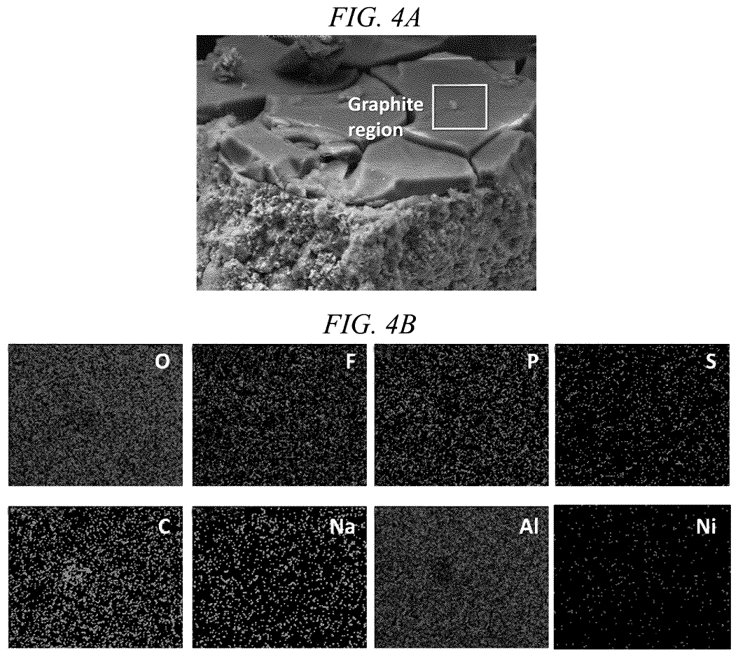

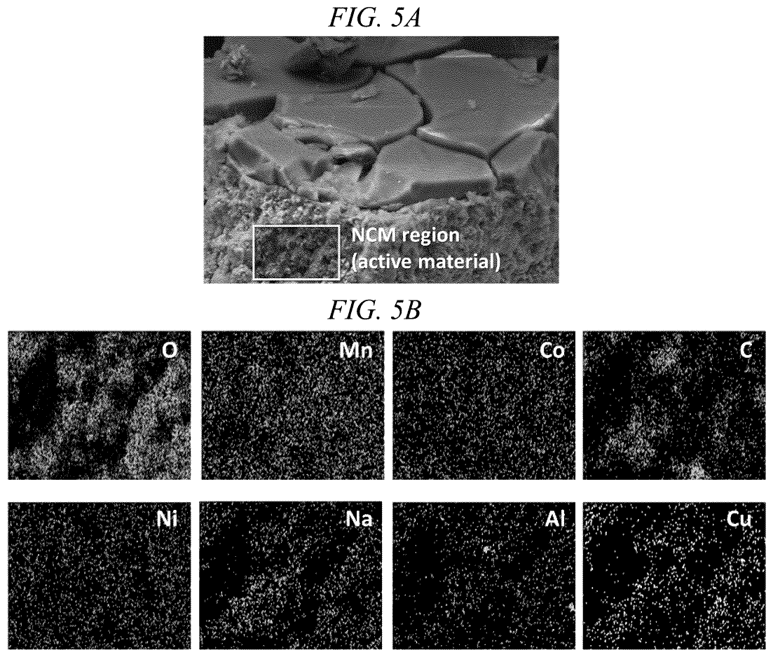

The black mass (BM-3) obtained in Example 1 was identified using an SEM (FIG. 3), and analyzed by SEM-EDS (SU-70 Hitachi; Energy X-MaxN EDS Horiba). The results are shown in FIGS. 4 and 5.

FIGS. 3A and 3B are SEM images when observing BM-3 at 1000× magnification, and graphite and NCM particles were observed in the black mass. FIGS. 3C and 3D are SEM images when observing BM-3 at 4000× magnification, and NCM particles, and NCM 111 particles fused with graphite were observed.

FIG. 4A specifies a portion of graphite region when observing BM-3 by the SEM at 1000× magnification, and FIG. 4B shows images obtained by EDS analyzing and mapping the corresponding portion by elements (O, F, P, S, C, Na, Al and Ni).

FIG. 5A specifies a portion of NCM region (active material) when observing BM-3 by the SEM at 4000× magnification, and FIG. 5B shows images obtained by EDS analyzing and mapping the corresponding portion by elements (O, Mn, Co, C, Ni, Na, Al and Cu).

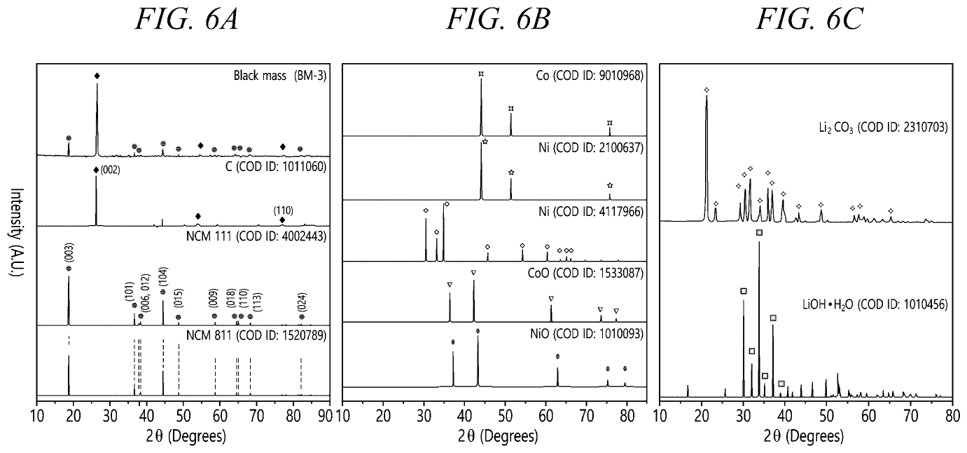

FIG. 6 compares XRD spectra of various components to analyze the components included in BM-3. FIG. 6A shows XRD spectra of BM-3, carbon (C), NCM 111 and NCM 811, FIG. 6B shows XRD spectra of Co, Ni, MnO, CoO and NiO, and FIG. 6C shows XRD spectra of Li₂CO₃ and LiOH·H₂O.

Then, BM-3 was analyzed by XPS to identify the composition, and the results are shown in the following Table 1.

TABLE 1

| Element | Content (wt %) | Element | Content (wt %) |
|---|---|---|---|
| Li | 3.27 ± 0.52 | Ni | 9.75 ± 0.44 |
| B | 0.05 ± 0.01 | Cu | 0.99 ± 0.08 |
| Na | 0.62 ± 0.04 | Zr | 0.06 ± 0.01 |
| Al | 4.62 ± 0.66 | Ba | 0.13 ± 0.03 |
| P | 0.24 ± 0.02 | C | 33.14 ± 0.46 |
| K | 0.17 ± 0.01 | H | 0.82 ± 0.01 |
| Ca | 0.05 ± 0 | N | 0.03 ± 0 |
| Mn | 6.79 ± 0.68 | S | 0.17 ± 0.03 |
| Fe | 0.02 ± 0.00 | O | 12.87 ± 0.03 |
| Co | 8.14 ± 0.43 | Others | 18.43 |

Properties of BM-3 were identified, and the results are shown in the following Table 2. Specifically, the moisture content was measured using an oven-drying method (110° C., 4 hours) in accordance with ASTM D2216. True density was measured using a liquid pycnometer method (solvent: water). Volume density was measured by recording volume and weight before tapping. Tan density was measured by recording a final volume after reaching a stable volume after tapping 100 times per minute.

TABLE 2

| Properties | Content (wt %) |
|---|---|
| True Density (ρ) (g/cm³) | 1.71 ± 0.14 |
| Tap Density (g/cm³) | 1.351 ± 0.028 |
| Volume Density (g/cm³) | 1.08 ± 0.003 |
| Moisture Content (%) | 1.105 ± 0.214 |

Referring to FIGS. 2 to 6 and Tables 1 and 2, it was identified that BM-3, black mass derived from lithium-ion battery waste, included a lithium composite oxide including NCM, and various impurities such as organic substances, partially degraded organic substances, graphite, aluminum, copper, iron and fluorine.

### Example 2. Production of Lithium Compounds from Lithium-Ion Battery Waste

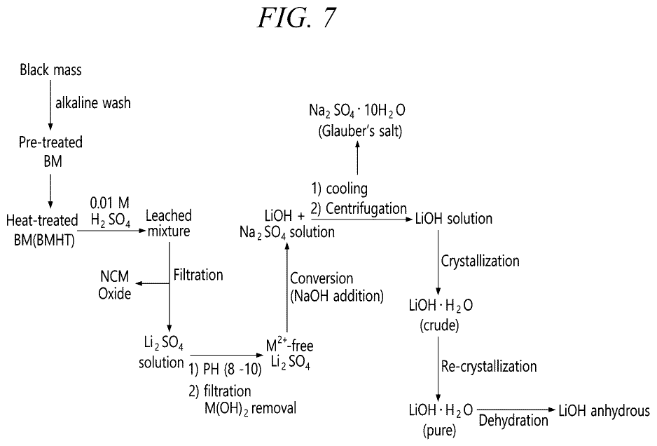

LiOH anhydride was produced as a final product using BM-3 obtained in Example 1. FIG. 7 is a schematic diagram illustrating a process of producing lithium compounds according to Example 2.

### (1) Alkali Washing

BM-3 (250 g) was washed with a NaOH solution (solid-liquid ratio 500 g/L) (500 mL) for 60 minutes at room temperature (25° C.). The washing solution was vacuum filtered to collect a solid, and then the solid was washed again with pure water for 60 minutes. The washing solution was air-dried for several days to obtain alkali washed BM-3.

The alkali washing was performed while varying the concentration of the NaOH solution to 1 M, 2 M, 3 M and 4 M, and BM-3 alkali washed at each concentration was dried, and then the composition was analyzed before and after the washing. The results are shown in the following Table 3 (in the table, a) indicates a case in which the standard deviation was rounded off to 0 due to insignificant measurement variability).

TABLE 3

| | Content | 1M NaOH | | 2M NaOH | | 3M NaOH | | 4M NaOH | |
|---|---|---|---|---|---|---|---|---|---|
| | before | | 98.60% | | 97.79% | | 97.44% | | 97.49% |
| | Treatment | Weight | % | Weight | % | Weight | % | Weight | % |
| Element | (wt %) | (wt %) | Retained | (wt %) | Retained | (wt %) | Retained | (wt %) | Retained |
| Li | 3.51 ± | 3.53 ± | 98.52 ± | 3.49 ± | 96.57 ± | 3.21 ± | 94.22 ± | 3.13 ± | 94.04 ± |
| | 0.20 | 0.11 | 0.11 | 0.03 | 0.39 | 0.06 | 7.67 | 0.01 | 7.66 |
| Al | 3.99 ± | 3.42 ± | 92.41 ± | 3.04 ± | 86.27 ± | 3.02 ± | 83.06 ± | 3.11 ± | 79.19 ± |
| | 0.45 | 0.21 | 15.46 | 0.03 | 14.96 | 0.09 | 14.75 | 0.02 | 14.45 |
| Mn | 9.72 ± | 10.27 ± | 99.83 ± | 10.42 ± | 99.95 ± | 9.97 ± | 99.99 ± | 9.7 ± | 99.99 ± |
| | 0.36 | 0.25 | 5.27 | 0.04 | 5.27 | 0.40 | 5.27 | 0.20 | 5.27 |
| Fe | 0.05 ± | 0.05 ± | 100 ± | 0.05 ± | 100 ± | 0.05 ± | 99.68 ± | 0.05 ± | 99.38 ± |
| | 0.01 | 0.00^{a)} | 0.00^{a)} | 0.06 | 0.00^{a)} | 0.01 | 26.47 | 0.00^{a)} | 26.42 |
| Co | 10.26 ± | 10.9 ± | 99.85 ± | 11.07 ± | 99.98 ± | 10.58 ± | 99.99 ± | 10.21 ± | 100 ± |
| | 0.31 | 0.33 | 4.21 | 0.05 | 4.21 | 0.32 | 4.21 | 0.16 | 4.21 |
| Ni | 10.59 ± | 11.31 ± | 99.82 ± | 11.26 ± | 100 ± | 10.76 ± | 99.99 ± | 10.44 ± | 100 ± |
| | 0.30 | 0.37 | 4.07 | 0.01 | 4.07 | 0.47 | 4.07 | 0.19 | 4.07 |
| Cu | 0.83 ± | 0.76 ± | 99.16 ± | 0.75 ± | 99.2 ± | 0.78 ± | 98.91 ± | 0.81 ± | 99.33 ± |
| | 0.03 | 0.02 | 4.85 | 0.01 | 4.84 | 0.00^{a)} | 4.83 | 0.03 | 4.84 |
| Zn | 0.53 ± | 0.66 ± | 96.2 ± | 0.6 ± | 97.26 ± | 0.46 ± | 99.8 ± | 0.52 ± | 99.45 ± |
| | 0.02 | 0.00^{a)} | 5.94 | 0.04 | 6.04 | 0.01 | 5.85 | 0.01 | 5.83 |
| Ba | 0.11 ± | 0.07 ± | 97.93 ± | 0.13 ± | 98.63 ± | 0.12 ± | 100 ± | 0.12 ± | 100 ± |
| | 0.01 | 0.06 | 18.55 | 0.00^{a)} | 18.6 | 0.01 | 18.67 | 0.00^{a)} | 18.67 |

Referring to Table 3, the mass of the black mass was maintained at about 97.44% by weight to 98.6% by weight when alkali washed and then dried, and the mass loss rate caused by the alkali washing was about 1.5% by weight to 3% by weight.

Even after the alkali washing with 1 M to 4 M NaOH, the lithium retention was identified to be 94% or more.

### (2) Thermal Treatment

Alkali washed BM-3 (10 g) was mixed with carbamide, a solid reductant (SR), using a mortar and pestle until the mixture turned dark grey. The mixture was placed in a rotary kiln (capacity 1.3 L), and the rotary kiln was evacuated, and then purged three times with nitrogen gas to remove oxygen. After that, while supplying nitrogen gas to the rotary kiln at 70 sccm, the rotary kiln was heated from room temperature to 550° C. at a temperature-raising rate of 10° C./minute, and kept for 30 minutes. The rotary kiln was naturally cooled, and when the temperature fell below 100° C. after 5 hours, the heat-treated BM-3 was recovered.

The thermal treatment was performed while varying the weight of the carbamide to 1 g, 2 g, 3 g, 4 g and 5 g, and the composition before and after the thermal treatment was analyzed depending on the weight ratio between the solid reductant (SR) carbamide (Car) and BM-3 alkali washed with 1 M NaOH. The results are shown in the following Tables 4 and 5 (in the table, a) indicates a case in which the standard deviation was rounded off to 0 due to insignificant measurement variability).

TABLE 4

| | | SR (Car):BM-3 | | SR (Car):BM-3 | | SR (Car):BM-3 | |
|---|---|---|---|---|---|---|---|
| | Content before | 0.1:1 | | 0.2:1 | | 0.3:1 | |
| | Thermal | | 95.61% | | 93.62% | | 93.09% |
| | Treatment | Weight | % | Weight | % | Weight | % |
| Element | (wt %) | (wt %) | Retained | (wt %) | Retained | (wt %) | Retained |
| Li | 3.44 ± | 3.64 ± | 100.2 ± | 3.46 ± | 94.2 ± | 3.64 ± | 98.42 ± |
| | 0.25 | 0.28 | 10.61 | 0.08 | 7.2 | 0.16 | 8.3 |
| Al | 3.67 ± | 4.47 ± | 100.51 ± | 3.96 ± | 101.02 ± | 4.03 ± | ~100 ± |
| | 0.23 | 0.39 | 12.46 | 0.07 | 6.49 | 0.15 | 7.3 |
| Mn | 11.52 ± | 12 ± | 99.54 ± | 12.57 ± | 100.16 ± | 12.11 ± | 97.8 ± |
| | 0.26 | 0.69 | 6.13 | 0.38 | 3.86 | 0.04 | 2.26 |
| Co | 11.83 ± | 12.64 ± | ~100 ± | 13.29 ± | ~100 ± | 12.8 ± | 100.7 ± |
| | 0.17 | 0.81 | 6.74 | 0.51 | 4.36 | 0.04 | 1.52 |
| Ni | 12.35 ± | 13.02 ± | 100.82 ± | 13.72 ± | ~100 ± | 13.27 ± | 100.04 ± |
| | 0.16 | 0.79 | 6.25 | 0.44 | 3.62 | 0.12 | 1.63 |
| Cu | 0.82 ± | 0.92 ± | ~100 ± | 0.85 ± | 97.04 ± | 0.92 ± | ~100 ± |
| | 0.03 | 0.04 | 6.01 | 0.03 | 5.42 | 0.05 | 6.66 |
| Zn | 0.64 ± | 0.67 ± | 100.07 ± | 0.71 ± | ~100 ± | 0.69 ± | 100.2 ± |
| | 0.00^{a)} | 0.04 | 6.02 | 0.02 | 3.35 | 0.03 | 4.79 |
| Ba | 0.02 ± | 0.02 ± | 100.76 ± | 0.02 ± | ~100 ± | 0.03 ± | ~100 ± |
| | 0.00^{a)} | 0.01 | 64.98 | 0.00^{a)} | 33.16 | 0.01 | 87.45 |

TABLE 5

| | Content | SR (Car):BM-3 | | SR (Car):BM-3 | |
|---|---|---|---|---|---|
| | before | 0.4:1 | | 0.5:1 | |
| | Thermal | | 94.87% | | 95.14% |
| | Treatment | Weight | % | Weight | % |
| Element | (wt %) | (wt %) | Retained | (wt %) | Retained |
| Li | 3.44 ± | 4.09 ± | ~100 ± | 4.13 ± | ~100 ± |
| | 0.25 | 0.05 | 8.29 | 0.03 | 8.34 |
| Al | 3.67 ± | 3.89 ± | 100.62 ± | 3.82 ± | 99.07 ± |
| | 0.23 | 0.01 | 6.19 | 0.03 | 6.14 |
| Mn | 11.52 ± | 11.94 ± | 98.32 ± | 12.34 ± | 100.88 ± |
| | 0.26 | 0.20 | 2.79 | 0.11 | 2.51 |
| Co | 11.83 ± | 12.71 ± | ~100 ± | 12.94 ± | ~100 ± |
| | 0.17 | 0.22 | 2.33 | 0.00^{a)} | 1.53 |
| Ni | 12.35 ± | 13.15 ± | ~100 ± | 13.38 ± | ~100 ± |
| | 0.16 | 0.24 | 2.26 | 0.03 | 1.39 |
| Cu | 0.82 ± | 0.86 ± | 99.73 ± | 0.87 ± | ~100 ± |
| | 0.03 | 0.05 | 7.2 | 0.01 | 3.99 |
| Zn | 0.64 ± | 0.67 ± | 99.46 ± | 0.7 ± | ~100 ± |
| | 0.00^{a)} | 0.01 | 1.74 | 0.02 | 2.71 |
| Ba | 0.02 ± | 0.02 ± | ~100 ± | 0.03 ± | ~100 ± |
| | 0.00^{a)} | 0.001 | 35.39 | 0.02 | 102.97 |

Referring to Tables 4 and 5, mass loss after the thermal treatment was about 5% by weight to 7% by weight, which was identified to be due to physical loss during the thermal treatment process in the furnace and oxygen removal caused by the proceeding of the thermal reduction reaction. Nevertheless, it was identified that the loss of lithium, manganese, nickel and cobalt was minimized.

### (3) Leaching

(1^{st}) To the heat-treated BM-3 (0.5 g), a 0.01 M H₂SO₄ solution (8 mL) was added. The BM-3 dispersion was stirred at 300 rpm for 20 minutes, and centrifuged (4000 rpm, 15 minutes) to separate the supernatant and the solid.

(2^{nd}) The supernatant was collected, and a 0.01 M H₂SO₄ solution (20 mL) (solid-liquid ratio 62.5 g/L) was added to the solid. The dispersion was stirred and centrifuged in the same manner. (3^{rd}) This process was repeated once more to obtain a final solid residue. The final solid residue includes nickel, manganese and cobalt, and therefore, may be recycled for the production of NCM materials.

BM-3 (total of 10 g scale) heat treated in the same manner was leached, and the supernatants (Li₂SO₄ solution) were all collected.

The results of leaching when the mass ratios between carbamide, the solid reductant during thermal treatment, and BM-3 are 0.3:1, 0.4:1 and 0.5:1 are shown in the following Tables 6 to 8, respectively. In the tables, m_{BM-3_i} represents the mass (mg) of element in the alkali-washed and heat-treated BM-3 (0.5 g), Cᵢ represents the concentration (mg/L) of element included in the leaching solution (8 mL) (V_{L}), mi^{L} represents the mass of element leached after the 1^{st} wash, mi^{L} total amount represents the total mass of element leached after the 2^{nd} and the 3^{rd} wash, and mi^{R} represents the mass of residual element remaining in BM-3 after the three washes.

TABLE 6

| 0.3:1 | | Cᵢ (mg/L) | mi^{L} (mg) | mi^{L} (mg) | mi^{L} | | |
|---|---|---|---|---|---|---|---|
| Thermal | M_{BM-3}_{_{—}}ᵢ (mg) | V_{L} = 8 mL | (1^{st} | (2^{nd} and 3^{rd} | Total Amount | mi^{R} | % |
| Treatment | (m_{BM-3} = 0.50 g) | (1^{st} Wash) | Wash) | Wash) | (mg) | (mg) | Leaching |
| Li | 18.16 ± | 1688 ± | 13.5 ± | 1.41 ± | 14.91 ± | 3.24 ± | 82.13 ± |
| | 0.78 | 111.72 | 0.89 | 1.21 | 0.81 | 0.22 | 5.67 |
| Na | 2.24 ± | 136.1 ± | 1.09 ± | 0.4 ± | 1.49 ± | 0.75 ± | 66.57 ± |
| | 0.47 | 4.53 | 0.04 | 0.73 | 0.73 | 0.55 | 35.26 |
| K | 0.28 ± | 10.65 ± | 0.09 ± | 0 ± | 0.03 ± | 0.25 ± | 11.74 ± |
| | 0.13 | 5.43 | 0.04 | 0 | 0.18 | 0.12 | 63.7 |
| Mn | 60.44 ± | 0.16 ± | 0 ± | 3.96 ± | 3.97 ± | 56.48 ± | 6.56 ± |
| | 0.22 | 0.23 | 0 | 2.37 | 2.37 | 2.36 | 3.92 |
| Fe | 0.19 ± | 9.87 ± | 0.08 ± | 0 ± | 0.01 ± | 0.19 ± | 4.01 ± |
| | 0.02 | 0.87 | 0.01 | 0 | 0.02 | 0.01 | 8.89 |
| Co | 63.91 ± | 0 ± | 0 ± | 4.12 ± | 4.12 ± | 59.79 ± | 6.45 ± |
| | 0.22 | 0 | 0 | 2.89 | 2.89 | 2.89 | 4.53 |
| Ni | 66.25 ± | 0.98 ± | 0.01 ± | 4.8 ± | 4.81 ± | 61.43 ± | 7.26 ± |
| | 0.62 | 1.38 | 0.01 | 2.72 | 2.72 | 2.65 | 4.1 |
| Zn | 3.46 ± | 3.78 ± | 0.03 ± | 0.22 ± | 0.25 ± | 3.21 ± | 7.1 ± |
| | 0.16 | 1.51 | 0.01 | 0.18 | 0.18 | 0.08 | 5.25 |
| Ba | 0.17 ± | 28.69 ± | 0.23 ± | 0 ± | 0.04 ± | 0.13 ± | 24.44 ± |
| | 0.07 | 3.37 | 0.03 | 0 | 0.1 | 0.08 | 63.06 |

TABLE 7

| 0.4:1 | | Cᵢ (mg/L) | mi^{L} (mg) | mi^{L} (mg) | mi^{L} | | |
|---|---|---|---|---|---|---|---|
| Thermal | m_{BM-3}_{_{—}}ᵢ | V_{L} = 8 mL | (1^{st} | (2^{nd} and | Total | mi^{R} | % |
| Treatment | (m_{BM-3} = 0.50 g) | (1^{st} Wash) | Wash) | 3^{rd} Wash) | Amount (mg) | (mg) | Leaching |
| Li | 20.52 ± | 1769 ± | 14.15 ± | 3.23 ± | 17.38 ± | 3.14 ± | 80.1 ± |
| | 0.23 | 108.89 | 0.87 | 1 | 0.49 | 0.43 | 2.58 |
| Na | 1.77 ± | 167.05 ± | 1.34 ± | 0 ± | 1.23 ± | 0.54 ± | 69.62 ± |
| | 0.05 | 32.74 | 0.26 | 0 | 0.1 | 0.08 | 5.84 |
| K | 0.2 ± | 15.01 ± | 0.12 ± | 0 ± | 0 ± | 0.21 ± | 0 ± |
| | 0.01 | 11.45 | 0.09 | 0 | 0 | 0.03 | 0 |
| Mn | 59.91 ± | 0 ± | 0 ± | 0.85 ± | 0.85 ± | 59.06 ± | 1.42 ± |
| | 1 | 0 | 0 | 1.55 | 1.55 | 1.18 | 2.59 |
| Fe | 0.22 ± | 9.26 ± | 0.07 ± | 0 ± | 0.04 ± | 0.18 ± | 18.07 ± |
| | 0.02 | 0.46 | 0 | 0 | 0.03 | 0.01 | 12.1 |
| Co | 63.76 ± | 0 ± | 0 ± | 1.57 ± | 1.57 ± | 62.19 ± | 2.47 ± |
| | 1.12 | 0 | 0 | 1.76 | 1.76 | 1.36 | 2.76 |
| Ni | 65.97 ± | 0 ± | 0 ± | 2 ± | 2 ± | 63.97 ± | 3.03 ± |
| | 1.18 | 0 | 0 | 1.92 | 1.92 | 1.51 | 2.91 |
| Zn | 3.38 ± | 0 ± | 0 ± | 0.14 ± | 0.14 ± | 3.25 ± | 4.03 ± |
| | 0.06 | 0 | 0 | 0.08 | 0.08 | 0.06 | 2.43 |
| Ba | 0.12 ± | 14.34 ± | 0.11 ± | 0 ± | 0.05 ± | 0.07 ± | 39.46 ± |
| | 0.01 | 2.57 | 0.02 | 0 | 0.01 | 0 | 12.39 |

TABLE 8

| 0.5:1 | | Cᵢ (mg/L) | mi^{L} (mg) | mi^{L} (mg) | mi^{L} | | |
|---|---|---|---|---|---|---|---|
| Thermal | m_{BM-3}_{_{—}}ᵢ | V_{L} = 8 mL | (1^{st} | (2^{nd} and | Total | mi^{R} | % |
| Treatment | (M_{BM-3} = 0.50 g) | (1^{st} Wash) | Wash) | 3^{rd} Wash) | Amount (mg) | (mg) | Leaching |
| Li | 20.94 ± | 1984.5 ± | 15.88 ± | 1.82 ± | 17.69 ± | 3.24 ± | 82.52 ± |
| | 0.14 | 91.22 | 0.73 | 0.76 | 0.23 | 0.18 | 1.22 |
| Na | 1.84 ± | 146.1 ± | 1.17 ± | 0 ± | 0.87 ± | 0.96 ± | 47.57 ± |
| | 0.29 | 42.14 | 0.34 | 0 | 0.29 | 0 | 17.34 |
| K | 0.2 ± | 0.2 ± | 0 ± | 0 ± | 0 ± | 0.2 ± | 0 ± |
| | 0.06 | 0.43 | 0 | 0 | 0 | 0.01 | 0 |
| Mn | 0.11 ± | 0 ± | 0 ± | 0.04 ± | 0.04 ± | 0.07 ± | 37.54 ± |
| | 0.15 | 0 | 0 | 0.18 | 0.18 | 0.09 | 174.82 |
| Fe | 62.49 ± | 0.69 ± | 0.01 ± | 0 ± | 0 ± | 66.55 ± | 0 ± |
| | 0.58 | 0.44 | 0 | 0 | 0 | 0.08 | 0 |
| Co | 0.18 ± | 7.96 ± | 0.06 ± | 0 ± | 0 ± | 0.21 ± | 0 ± |
| | 0.01 | 5.37 | 0.04 | 0 | 0 | 0 | 0 |
| Ni | 65.53 ± | 0 ± | 0 ± | 0 ± | 0 ± | 70.03 ± | 0 ± |
| | 0.01 | 0 | 0 | 0 | 0 | 0.7 | 0 |
| Zn | 67.77 ± | 0.94 ± | 0.01 ± | 0 ± | 0 ± | 71.79 ± | 0 ± |
| | 0.15 | 1.32 | 0.01 | 0 | 0 | 0.86 | 0 |
| Ba | 3.53 ± | 1.61 ± | 0.01 ± | 0 ± | 0 ± | 3.72 ± | 0 ± |
| | 0.09 | 2.28 | 0.02 | 0 | 0 | 0.06 | 0 |

Referring to Tables 6 to 8, total lithium leaching efficiency was identified to be 80% or more. Minor co-leaching of nickel, cobalt and manganese was also identified as well as lithium, however, the amount of co-leaching was able to be reduced by increasing the ratio of the solid reductant used.

### (4) Conversion

The Li₂SO₄ solution (composition indicated as “Li₂SO₄ solution” of the following Table 9) was evaporated and concentrated (80° C., 2 hours to 6 hours) until at least 80% to 90% of water evaporated, and then NaOH was added to the evaporated and concentrated Li₂SO₄ solution (composition indicated as “evaporated and concentrated Li₂SO₄ solution” of the following Table 9) to slowly adjust the pH to 8 to 10 and to precipitate remaining metal (M) impurities in the form of hydroxides (M(OH)₂), and the resulting solution was filtered under nitrogen gas to obtain a clear solution. 16 M NaOH was added to the solution to promote conversion into LiOH and Na₂SO₄, and as a result, a dispersion including LiOH and Na₂SO₄ was obtained. The dispersion was frozen at −15° C. for 12 hours, centrifuged (8000 rpm, 15 minutes) to separate Na₂SO₄·10H₂O (Glauber's salt), and filtered to obtain a supernatant (composition indicated as “supernatant” of the following Table 9). The filtered supernatant was evaporated and crystallized under nitrogen gas until LiOH monohydrate crystals were obtained to obtain crude LiOH monohydrate. The crude LiOH monohydrate was recrystallized (evaporated and crystallized twice) to obtain pure LiOH monohydrate. The LiOH monohydrate was dried in a vacuum oven for 48 hours at 60° C. to 70° C. under nitrogen gas to remove remaining moisture, and LiOH anhydride, a final product, was obtained.

TABLE 9

| | Li₂SO₄ | Evaporated and Concentrated | Supernatant |
|---|---|---|---|
| Element | Solution (mg/L) | Li₂SO₄ Solution (mg/L) | (mg/L) |
| Li | 5,622.00 | 26,730.00 | 23,685.00 |
| Na | 530.70 | 3,123.00 | 55,480.00 |
| Mg | 2.69 | 20.09 | 9.88 |
| Al | 12.43 | 75.66 | 57.26 |
| K | 283.15 | 1,485.50 | 1,407.50 |
| Ca | 13.07 | 108.65 | 73.77 |
| Mn | 674.50 | 3,421.50 | 0.37 |
| Fe | 2.05 | 77.08 | 4.16 |
| Co | 201.05 | 1,021.55 | 0.74 |
| Ni | 147.90 | 775.20 | 0.58 |
| Cu | 1.08 | 7.57 | 0.72 |
| Zn | 18.83 | 217.20 | 180.65 |
| Ba | 2.19 | 246.30 | 273.75 |
| pH | 2.80 | ~2 | >12 |

### Example 3. Production of Lithium Compounds from Lithium-Ion Battery Waste

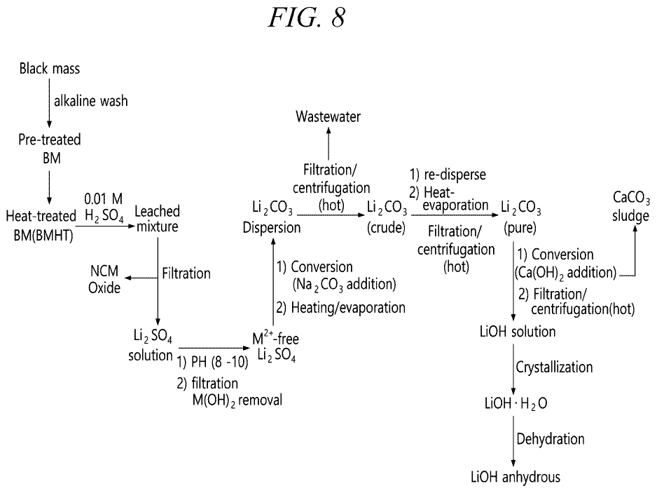

FIG. 8 is a schematic diagram illustrating a process of producing lithium compounds according to Example 3. Alkali washing, thermal treatment and leaching were performed in the same manner as in Example 2, and Li₂CO₃ was produced as a final product by the following conversion.

### (4) Conversion

The Li₂SO₄ solution (composition indicated as “Li₂SO₄ solution” of the following Table 10) was evaporated and concentrated (80° C., 2 hours to 6 hours) until at least 80% to 90% of water evaporated, and then NaOH was added to the evaporated and concentrated Li₂SO₄ solution (composition indicated as “evaporated and concentrated Li₂SO₄ solution” of the following Table 10) to slowly adjust the pH to 8 to 10 and to precipitate remaining metal (M) impurities in the form of hydroxides (M(OH)₂), and the resulting solution was filtered under nitrogen gas to obtain a clear solution (composition indicated as “supernatant” of the following Table 10).

The solution (100 mL) was heated to 80° C., and a saturated Na₂CO₃ solution (72 g) was slowly added thereto. The solution was left unattended to evaporate until the final volume became 40 mL, and Li₂CO₃ precipitate was obtained and centrifuged (4000 rpm, 5 minutes) with a recovery rate of 88%. The precipitate was redissolved in water (100 mL), and the solution was left unattended to evaporate until the final volume became 40 mL. A precipitate was obtained again and centrifuged (4000 rpm, 5 minutes), and as a result, Li₂CO₃, a final precipitate powder product, was obtained.

TABLE 10

| | Li₂SO₄ | Evaporated and Concentrated | Supernatant |
|---|---|---|---|
| Element | Solution (mg/L) | Li₂SO₄ Solution (mg/L) | (mg/L) |
| Li | 3,750.50 | 26,665.00 | 23,290.00 |
| Na | 259.40 | 2,387.50 | 3,119.50 |
| Mg | 2.14 | 16.99 | 1.16 |
| Al | 39.17 | 145.80 | 8.13 |
| K | 667.30 | 3,944.50 | 3,064.50 |
| Ca | 14.86 | 113.95 | 7.85 |
| Mn | 1.64 | 21.40 | 2.37 |
| Fe | 0.87 | 113.15 | 0.80 |
| Co | 0.38 | 5.06 | 0.35 |
| Ni | 0.15 | 18.54 | 3.69 |
| Cu | 0.22 | 0.91 | 0.07 |
| Zn | 35.04 | 267.15 | 16.85 |
| Ba | 6.94 | 194.05 | 0.00 |
| pH | 2.84 | ~2 | 7-8 |

### Example 4. Production of Lithium Compounds from Lithium-Ion Battery Waste

FIG. 8 is a schematic diagram illustrating a process of producing lithium compounds according to Example 4. Li₂CO₃ produced according to Example 3 was used, and LiOH anhydride was produced as a final product through the following (4) additional conversion.

### (4) Conversion

Precipitate Li₂CO₃ produced according to Example 3 was reacted with Ca(OH)₂ (2 hours at 80° C. under nitrogen gas) in a 130 mL reaction volume at a 1.1-fold equivalent or in a 10 mol % excess. The reaction material was filtered without cooling under nitrogen gas to separate CaCO₃ sludge (moisture content 35% to 50%), and 3% by weight of a LiOH solution was obtained. The LiOH solution was evaporated and crystallized to obtain LiOH monohydrate crystals. The LiOH monohydrate was dried in a vacuum oven for 48 hours at 60° C. to 70° C. under nitrogen gas to remove remaining moisture, and LiOH anhydride, a final product, was obtained.

### Experimental Example 2. Identification of Alkali Washing Effect

After performing the alkali washing in Example 2, the concentration of fluorine (F) included in the alkali solution was identified, and the result is shown in the following Table 11. As a control group, water was used instead of the alkali solution for washing, and the concentration of fluorine included in water was identified.

TABLE 11

| Solution | Fluorine Concentration in Washing Solution (mg/L) |
|---|---|
| Water | 1,040 |
| 1M NaOH | 8,200 |
| 4M NaOH | 6,700 |

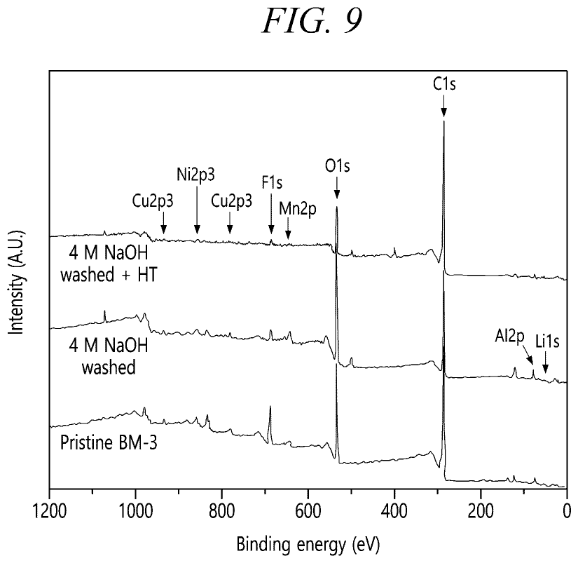

The black mass before the alkali washing, the black mass after the alkali washing with 4 M NaOH, and the black mass after the thermal treatment in Example 2 were each recovered and XPS analyzed, and the results are shown in FIG. 9. Referring to FIG. 9, it was identified that fluorine was the most depleted element by the alkali washing.

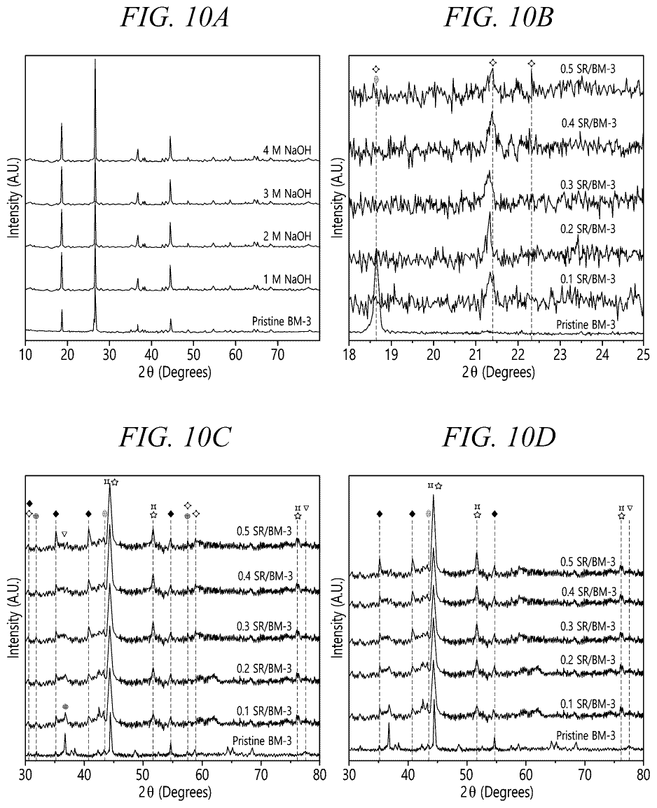

XRD analyses were performed before and after the alkali washing in Example 2, and the spectra are shown in FIG. 10A. Referring to FIG. 10A, in the alkali solution concentration range of 1 M to 4 M, no structural changes caused by the alkali washing occurred in the black mass.

Referring to Table 11, and FIGS. 9 and 10, the results show that the alkali washing according to the Example removed only the impurities without affecting the core lattice structure of the black mass.

### Experimental Example 3. Identification of Thermal Treatment Effect

XRD analysis results depending on the weight ratio between the solid reductant (SR) and the black mass (BM-3) used before after performing the thermal treatment in Example 2 are shown in FIGS. 10B and 10C.

Referring to FIG. 10B, the peak of pure BM-3 disappeared (refer to FIG. 6A), and the peak of Li₂CO₃ appeared (refer to FIG. 6C) in the range of 2θ=18° to 25°.

Referring to FIG. 10C, the peak of pure BM-3 disappeared (refer to FIG. 6A), and the peaks of NiO, MnO, CoO, zero-valent Ni and zero-valent Co appeared (refer to FIG. 6) in the range of 2θ=30° to 80°.

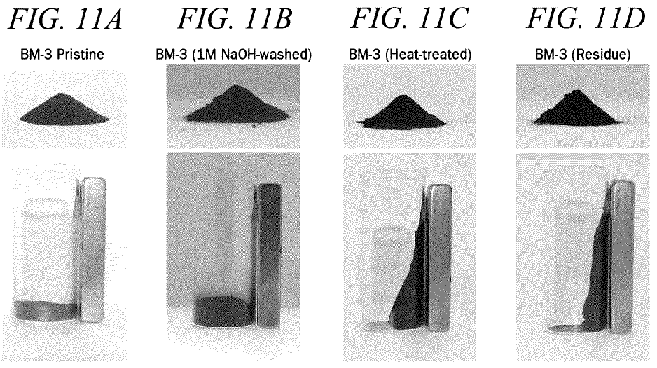

FIGS. 11A to 11D are images presenting appearances of black mass (FIG. 11A, pure BM-3), alkali-washed black mass (FIG. 11B, washing with 1 M NaOH), heat-treated black mass (FIG. 11C) and leached black mass (FIG. 11D) according to Example 2, and changes when a permanent magnet is touched to each thereof.

Referring to FIG. 11C, appearance of ferromagnetic properties after the thermal treatment indicates the formation of metallic nickel and metallic cobalt, and shows that thermal reduction of the lithium composite oxide is achieved by the thermal treatment. The magnetic phenomenon identified in FIG. 11C indicates the presence of non-sintered components formed by successful thermal reduction (zero-valent Ni, zero-valent Co and the like).

FIGS. 12A to 12D are SEM images (12A: 1000× magnification, 12B to 12D: 4000× magnification) of black mass (FIG. 12A, pure BM-3), and alkali-washed black mass (FIG. 12B, washing with 1 M NaOH), heat-treated black mass (FIG. 12C) and leached black mass (FIG. 12D) according to Example 2.

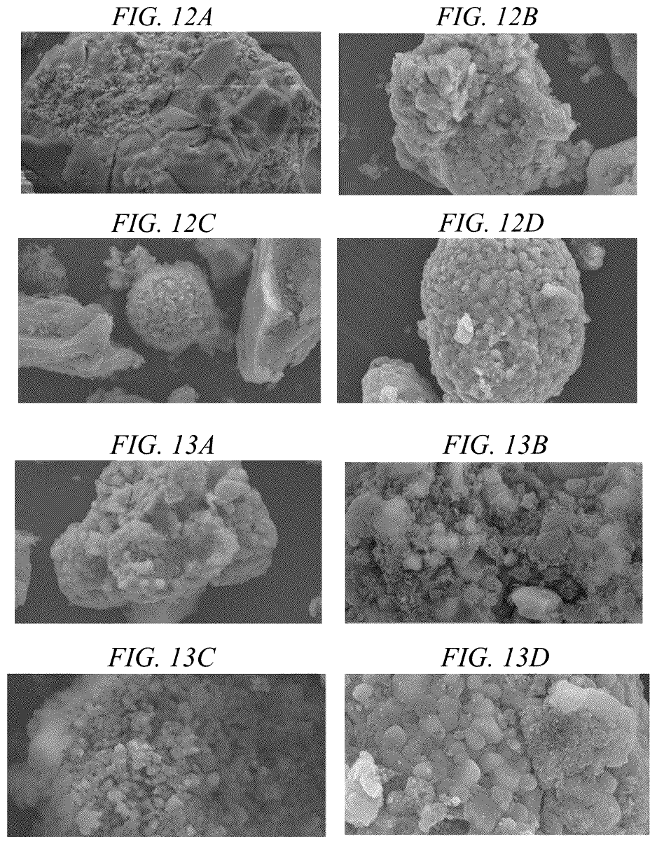

FIGS. 13A to 13D are SEM images (FIG. 13A: 4000× magnification, FIGS. 13B to 13D: 10000× magnification) of black mass (FIG. 13A, pure BM-3), and alkali-washed black mass (FIG. 13B, washing with 1 M NaOH), heat-treated black mass (FIG. 13C) and leached black mass (FIG. 13D) according to Example 2.

Referring to FIGS. 12C and 13C, the thermal treatment resulted in a more disordered structure and more amorphous regions compared to before the treatment (FIGS. 12A and 13A) and after the alkali washing (FIGS. 12B and 13B). Such changes in the appearance support the fact that significant changes occur in the core lattice structure of the active material included in the black mass due to the thermal reduction.

### Experimental Example 4. Identification of Leaching Effect

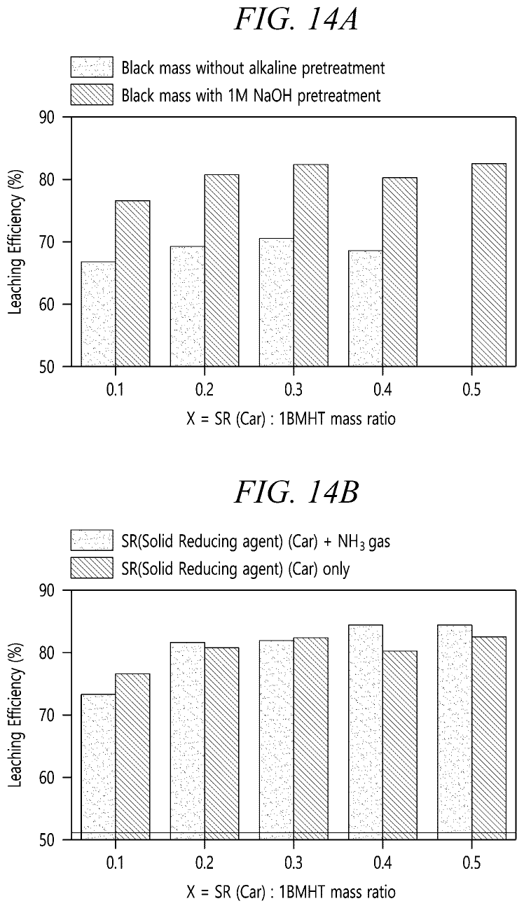

In the leaching of Example 2, total lithium leaching efficiency depending on the alkali washing is shown in FIG. 14A. As a control group, black mass heat treated without alkali washing was used.

Referring to FIG. 14A, total lithium leaching efficiency was about 80%, identifying that leaching efficiency was higher compared to leaching efficiency of less than 70% in the control group. Such a result shows that the presence of fluorine remaining in the black mass negatively affects thermal reduction efficiency and leaching efficiency of lithium ions.

FIG. 14B is a graph showing total lithium leaching efficiency for the black mass heat treated while varying the ratio of the solid reductant (SR(Car)) used after the alkali washing, and the use of a reducing gas (NH₃).

Referring to FIG. 14B, the use of a reducing gas as an auxiliary reductant increased thermal reduction efficiency, thereby increasing total lithium leaching efficiency from about 81% to about 84%.

Referring to FIGS. 12D and 13D, the SEM images of the leached black mass showed a loss of amorphous region. This suggests that the lost portion is related to lithium component elution, which is consistent with the result in which the peak of the lithium salt disappeared in the XRD spectrum after leaching of FIG. 10D.

### Experimental Example 5. Identification of Compositions, Properties and Recovery Rates of Lithium Compounds Produced in Examples

Components, masses and purity of the lithium compounds included in the final products produced according to Examples 2 to 4 were identified, and the results are shown in the following Table 12.

TABLE 12

| | Example 2 | Example 3 | Example 4 |
|---|---|---|---|
| Component | LiOH (mg/kg) | Li₂CO₃ (mg/kg) | LiOH (mg/kg) |
| Li | 203,339.30 | 178,009.54 | 141,287.58 |
| Na | 30,282.25 | 7,757.25 | 109,562.90 |
| Mg | 0.00 | 0.00 | 0.00 |
| Al | 85.07 | 0.00 | 40.25 |
| K | 713.97 | 388.56 | 1,896.36 |
| Ca | 0.00 | 0.00 | 156.55 |
| Mn | 0.00 | 26.42 | 1.88 |
| Fe | 5.47 | 1.89 | 3.76 |
| Co | 0.70 | 2.98 | 2.77 |
| Ni | 0.89 | 40.23 | 8.70 |
| Cu | 0.10 | 0.70 | 1.58 |
| Zn | 0.00 | 0.00 | 0.00 |
| Ba | 0.00 | 0.00 | 0.00 |
| OH⁻ | 515,864.36 | 0.00 | 382,203.80 |
| CO₃²⁻ | 71,839.01 | 840,712.30 | 34,606.37 |
| TN | 0.00 | 0.00 | 0.00 |
| Cl⁻ | 1.15 | 1.08 | 4.08 |
| SO₄²⁻ | 114.74 | 0.00 | 127.36 |
| NO₃⁻ | 0.00 | 0.00 | 0.00 |
| F⁻ | 0.86 | 0.75 | 0.96 |
| Mass (g) | 1.22 | 11.34 | 4.30 |
| Purity (%) | 70.16 | 94.75 | 48.75 |
| | (Anhydride) | | (Anhydride) |
| | 122.95 | | 85.43 |
| | (Monohydrate) | | (Monohydrate) |

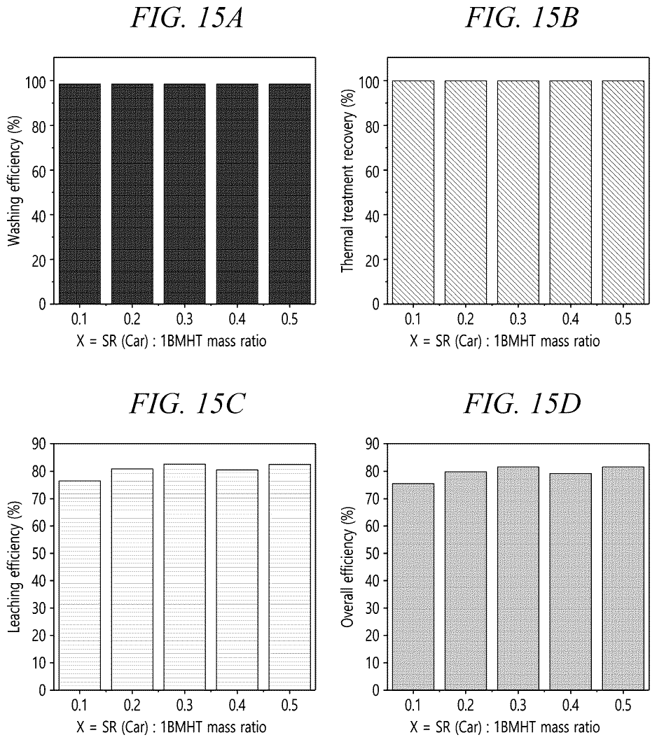

FIGS. 15A to 15D are graphs showing lithium recovery efficiency depending on the ratio of the solid reductant (FIG. 15A), lithium recovery efficiency depending on the ratio of the solid reductant during the thermal treatment (FIG. 15B), lithium recovery efficiency depending on the ratio of the solid reductant during the leaching (FIG. 15C), and total lithium recovery efficiency depending on the ratio of the solid reductant (FIG. 15D) in Example 2.

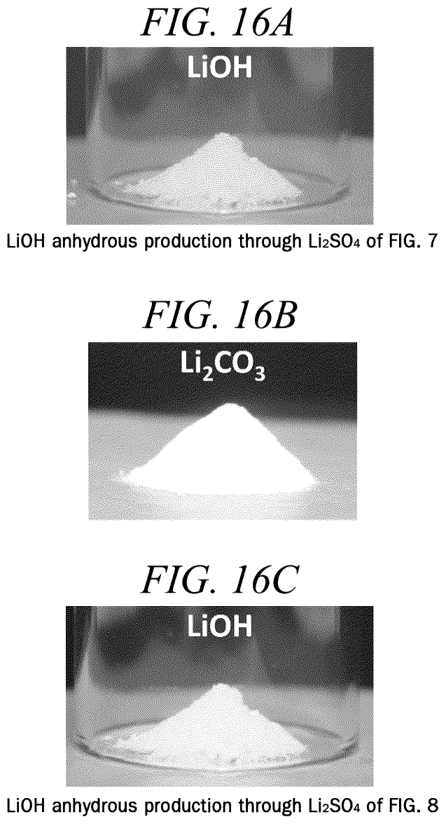

FIG. 16 shows images of the lithium compounds as a final product obtained in each of the Examples. FIGS. 16A to 16C are images of LiOH obtained in Example 2 (FIG. 16A), Li₂CO₃ obtained in Example 3 (FIG. 16B), and LiOH obtained in Example 4 (FIG. 16C).

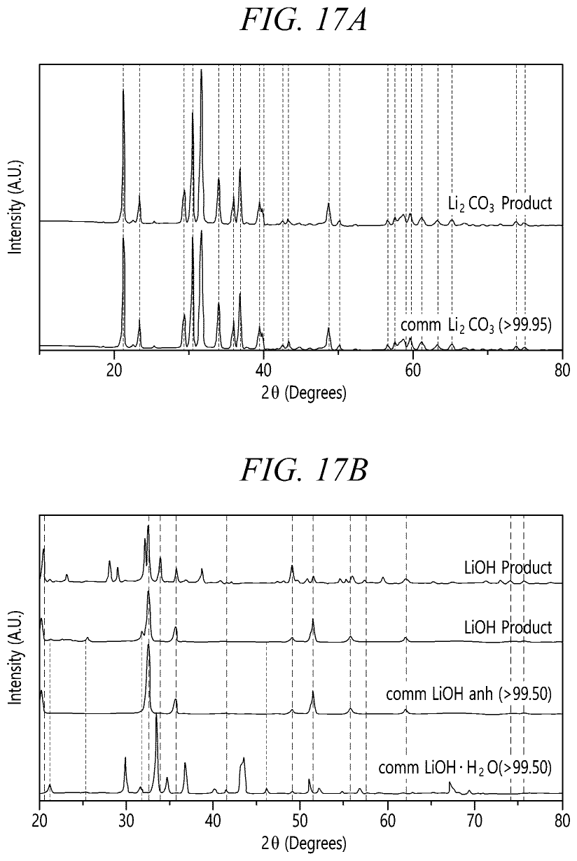

The final product (product) obtained in each of the Examples was analyzed by XRD and compared with a commercially available product (comm), and the results are shown in FIGS. 17A and 17B.

What is claimed is:

1. A method of producing lithium compounds from lithium-ion battery waste, the method comprising:
separating black mass from lithium-ion battery waste;
alkali washing the black mass;
performing thermal treatment on the alkali-washed black mass with a reductant;
acid leaching the heat-treated black mass; and
converting the acid leachate into lithium compounds.

2. The method of claim 1, wherein the black mass includes LiₐMe_{b}O_{c} (Me is at least one selected from the group consisting of Ni, Co, Mn, Al, Cu, Fe, Mg, B, Ga, Zn, Ta and V, and a, b and c are each independently a real number of 0.01 or more), and impurities that do not include lithium.

3. The method of claim 1, wherein the black mass includes particles having a particle diameter of 100 μm or less.

4. The method of claim 1, wherein the alkali washing is performed at a solid-liquid ratio of 250 g/L to 1000 g/L using a 1 M to 5 M NaOH or KOH solution.

5. The method of claim 1, wherein the reductant is at least one solid reductant selected from the group consisting of carbamide, ammonium carbonate, ammonium formate, ammonium oxalate and ammonium carbamate, at least one gas reductant selected from the group consisting of ammonia, hydrogen and carbon monoxide, or a combination thereof.

6. The method of claim 5, wherein the thermal treatment involves mixing the alkali-washed black mass and the solid reductant in a mass ratio of 1:0.1 to 1:2 and heat treating the mixture.

7. The method of claim 1, wherein the thermal treatment involves heating the mixture to 400° C. to 650° C. under an inert gas.

8. The method of claim 1, wherein the acid leaching involves adding an acid to the heat-treated black mass at a solid-liquid ratio of 40 g/L to 80 g/L to maintain a pH at 1 to 4.

9. The method of claim 1, wherein the converting into lithium compounds involves adding NaOH to the acid leachate to obtain LiOH or a hydrate thereof.

10. The method of claim 1, wherein the converting into lithium compounds involves adding Na₂CO₃ to the acid leachate to obtain Li₂CO₃.

11. The method of claim 10, wherein the converting into lithium compounds further includes adding Ca(OH)₂ to the Li₂CO₃ to produce LiOH or a hydrate thereof.
